(19) United States
(12) Patent Application Publication
(10) Pub. No.: US 2018/0041886 A1
(43) Pub. Date: Feb. 8, 2018

(54) APPARATUS AND METHOD FOR PROXIMITY-BASED SERVICE COMMUNICATION

(71) Applicant: NEC CORPORATION, Tokyo (JP)

(72) Inventors: Hiroaki AMINAKA, Tokyo (JP); Hisashi FUTAKI, Tokyo (JP)

(21) Appl. No.: 15/551,818

(22) PCT Filed: Nov. 17, 2015
(86) PCT No.: PCT/JP2015/005712

§ 371 Date: Aug. 17, 2017

(30) Foreign Application Priority Data
Feb. 26, 2015 (JP) 2015-036286

(51) Int. Cl. H04W 8/00; G01S 5/00; H04W 64/00; H04W 4/02; H04W 24/10

(52) U.S. Cl. CPC H04W 8/005; H04W 4/028; H04W 24/10; H04W 64/003; G01S 5/0027

(57) ABSTRACT

A control apparatus (4) is configured to perform a network-level discovery including tracking current locations of first and second radio terminals (1A, 1B) to detect proximity of the first and second radio terminals (1A and 1B). The control apparatus (4) is configured to acquire at least a location history of the first radio terminal (1 A) before starting the network-level discovery triggered by a request for the network-level discovery issued from the first radio terminal (1A). It is thus, for example, possible to improve accuracy of a determination whether to start network-level discovery (e.g., EPC-level ProSe Discovery).

### TECHNICAL FIELD

The present application relates to Proximity-based services (ProSe) and, in particular, to control of a network-level discovery.

### BACKGROUND ART

The 3GPP Release 12 specifies Proximity-based services (ProSe) (see, for example, Non-patent Literature 1). ProSe includes a ProSe discovery and ProSe direct communication. ProSe discovery makes it possible to detect proximity of radio terminals. ProSe discovery includes direct discovery (ProSe Direct Discovery) and network-level discovery (EPC-level ProSe Discovery).

ProSe Direct Discovery is performed through a procedure in which a radio terminal capable of performing ProSe (i.e., ProSe-enabled UE) detects another ProSe-enabled UE by using only the capability of a radio communication technology (e.g., Evolved Universal Terrestrial Radio Access (E-UTRA) technology) possessed by these UEs. On the other hand, in EPC-level ProSe Discovery, a core network (i.e., Evolved Packet Core (EPC)) determines proximity of two ProSe-enabled UEs and notifies these UEs of detection of proximity. ProSe Direct Discovery may be performed by three or more ProSe-enabled UEs.

ProSe direct communication enables establishment of a communication path between two or more ProSe-enabled UEs existing in a direct communication range after the ProSe discovery procedure is performed. In other words, ProSe direct communication enables a ProSe-enabled UE to directly communicate with another ProSe-enabled UE, without communicating through a Public Land Mobile Network (PLMN) including a base station (eNodeB). ProSe direct communication may be performed by using a radio communication technology that is also used to access a base station (an eNodeB) (i.e., E-UTRA technology) or by using a wireless local area network (WLAN) radio technology (i.e., IEEE 802.11 radio technology).

According to 3GPP Release 12, a ProSe function communicates with a ProSe-enabled UE through a Public Land Mobile Network (PLMN) and assists ProSe discovery and ProSe direct communication. The ProSe function is a logical function that is used for PLMN-related operations required for ProSe. The functionality provided by the ProSe function includes, for example: (a) communication with third-party applications (a ProSe Application Server); (b) authentication of a UE for ProSe discovery and ProSe direct communication; (c) transmission of configuration information for ProSe discovery and ProSe direct communication (e.g., EPC-ProSe-User ID) to a UE; and (d) provision of network-level discovery (i.e., EPC-level ProSe discovery). The ProSe function may be implemented in one or more network nodes or entities. In this specification, one or more network nodes or entities that implement the ProSe function are referred to as a “ProSe function entity” or a “ProSe function server”.

As described above, in EPC-level ProSe Discovery, a core network (i.e., Evolved Packet Core (EPC)) determines proximity of ProSe-enabled UEs and notifies these UEs of detection of proximity. EPC-level ProSe Discovery includes collection (or acquisition or monitoring) of locations of the two ProSe-enabled UEs performed by the EPC. That is, in EPC-level ProSe Discovery, UEs intermittently transmit to the EPC their location information by which the position of these UEs can be estimated and the EPC (i.e., ProSe function entity) determines proximity of the UEs based on the location information received from these UEs.

Note that 3GPP Release 12 ProSe is one example of proximity-based services (ProSe) that are provided based on geographic proximity of a plurality of radio terminals. Similarly to 3GPP Release 12 ProSe, the proximity-based service in a public land mobile network (PLMN) includes discovery and direct-communication phases assisted by a function or a node (e.g., ProSe function) located in the network. In the discovery phase, geographic proximity of radio terminals is determined or detected. In the direct communication phase, the radio terminals perform direct communication. The direct communication is performed between radio terminals in proximity to each other, without communicating through a public land mobile network (PLMN). The direct communication is also referred to as “device-to-device (D2D) communication” or “peer-to-peer communication”, in this specification, the term “ProSe” is not limited to 3GPP Release 12 ProSe and refers to proximity-based service communication including at least one of the discovery and the direct communication. Further, each of the terms “proximity-based service communication” and “ProSe communication” in this specification refers to at least one of the discovery and the direct communication.

The term “public land mobile network (PLMN)” in this specification indicates a wide-area radio infrastructure network, and means a multiple-access mobile communication system. The multiple-access mobile communication system enables mobile terminals to perform radio communication substantially simultaneously by sharing radio resources including at least one of time resources, frequency resources, and transmission power resources among the mobile terminals. Typical examples of multiple-access technology include Time Division Multiple Access (TDMA), Frequency Division Multiple Access (FDMA), Code Division Multiple Access (CDMA), Orthogonal Frequency Division Multiple Access (OFDMA), and any combination thereof. The public land mobile network includes a radio access network and a core network. Examples of the public land mobile network include a 3GPP Universal Mobile Telecommunications System (UMTS), a 3GPP Evolved Packet System (EPS), a 3GPP2 CDMA2000 system, a Global System for Mobile communications (GSM (Registered Trademark))/General packet radio service (GPRS) system, a WiMAX system, and a mobile WiMAX system. The EPS includes a Long Term Evolution (LTE) system and an LTE-Advanced system.

### CITATION LIST

### Non Patent Literature

Non-patent Literature 1:3GPP TS 23.303 V12.3.0 (2014 December), “3rd Generation Partnership Project; Technical Specification Group Services and System Aspects; Proximity-based services (ProSe); Stage 2 (Release 12)”, December 2014

### SUMMARY OF INVENTION

### Technical Problem

The detailed procedure for EPC-level ProSe discovery is disclosed in, for example. Section 5.5 “EPC-level ProSe Discovery procedures” of Non-patent Literature 1. According to this procedure, a ProSe function A receives a request for EPC-level ProSe discovery (i.e., Proximity Request) from a ProSe-enabled UE (UE A). The proximity request indicates an identifier of a ProSe-enabled UE (UE B), UE A's Current Location, and a time window. The time window indicates a time period during which the request by the UE A is valid. Next, the ProSe function A sends the proximity request to a ProSe function B that manages the UE B.

The ProSe function B determines whether to accept the proximity request. In an example, the ProSe function B may receive the last known location of the UE B from a Home Subscriber Server (an HSS). Then, the ProSe function B may determine that the UE A and the UE B are unlikely to enter proximity to each other within the requested time window based on the UE B's last known location, the UE A's current location, and the time window. In this case, the ProSe function B sends a message for rejecting the proximity request (i.e., Proximity Request Reject). This reject message indicates a cause value corresponding to a state where proximity is unlikely to be detected within the requested time window (i.e., “Proximity detection unlikely within requested time window”).

However, taking into account only the UE A's current location and the UE B's last known location in order to determine whether to start network-level discovery could be unsatisfactory in regard to the accuracy of the determination. This is because the UE A's current location and the UE B's last known location alone are insufficient to estimate, for example, the moving directions of the UEs A and B or whether they entered proximity to each other in the past, and thus it is difficult to appropriately evaluate a possibility of proximity of the UEs A and B in the future. Therefore, one of the objects to be attained by embodiments disclosed herein is to provide an apparatus, a method, and a program that contribute to improving accuracy of a determination whether to start network-level discovery (e.g., EEC-level ProSe Discovery).

### Solution to Problem

In a first aspect, a control apparatus includes a memory and at least one processor coupled to the memory. The at least one processor is configured to: control a network-level discovery including tracking current locations of first and second radio terminals to detect proximity of the first and second radio terminals; and acquire at least a location history of the first radio terminal before starting the network-level discovery triggered by a request for the network-level discovery issued from the first radio terminal.

In a second aspect, a radio terminal apparatus includes a memory and at least one processor coupled to the memory. The at least one processor is configured to; request a control apparatus to perform a network-level discovery including tracking current locations of the radio terminal apparatus and another radio terminal to detect proximity of the radio terminal apparatus and the another radio terminal; and send, before the network-level discovery is started, a location history of the radio terminal apparatus to the control apparatus directly or through a server.

In a third aspect, a method performed by a control apparatus includes: (a) performing a network-level discovery including tracking current locations of first and second radio terminals to detect proximity of the first and second radio terminals; and (b) acquiring at least a location history of the first radio terminal before starting the network-level discovery triggered by a request for the network-level discovery issued from the first radio terminal.

In a fourth aspect, a method performed by a radio terminal apparatus includes: (a) requesting a control apparatus to perform a network-level discovery including tracking current locations of the radio terminal apparatus and another radio terminal to detect proximity of the radio terminal apparatus and the another radio terminal; and (b) sending, before the network-level discovery is started, a location history of the radio terminal apparatus to the control apparatus directly or through a server.

In a fifth aspect, a program includes a set of instructions (software codes) that, when loaded into a computer, causes the computer to perform a method according to the above-described third or fourth aspect.

### Advantageous Effects of Invention

According to the above-described aspects, it is possible to provide an apparatus, a method, and a program that contribute to improving accuracy of a determination whether to start network-level discovery (e.g., EPC-level ProSe Discovery).

### BRIEF DESCRIPTION OF DRAWINGS

FIG. 1 shows a configuration example of a public land mobile network according to several embodiments;

FIG. 2 shows a configuration example of a public land mobile network according to several embodiments;

FIG. 3 shows a configuration example of a public land mobile network according to several embodiments;

FIG. 4 is a sequence diagram showing an example of an EPC-level ProSe Discovery procedure according to several embodiments;

FIG. 5 is a sequence diagram showing an example of a location history acquisition operation according to a first embodiment;

FIG. 6 is a sequence diagram showing an example of a location history acquisition operation according to the first embodiment;

FIG. 7 is a sequence diagram showing an example of a location history acquisition operation according to the first embodiment;

FIG. 8A is a sequence diagram showing an example of an EPC-level ProSe Discovery procedure according to a second embodiment;

FIG. 8B is a sequence diagram showing an example of an EPC-level ProSe Discovery procedure according to the second embodiment;

FIG. 9A is a sequence diagram showing an example of an EPC-level ProSe Discovery procedure according to the second embodiment;

FIG. 9B is a sequence diagram showing an example of an EPC-level ProSe Discovery procedure according to the second embodiment;

FIG. 10 is a flowchart showing an example of an operation performed by a ProSe function entity according to the second embodiment;

FIG. 11 is block diagram showing a configuration example of a ProSe function entity according to several embodiments; and

FIG. 12 is block diagram showing a configuration example of a UE according to several embodiments.

### DESCRIPTION OF EMBODIMENTS

Specific embodiments are explained hereinafter in detail with reference to the drawings. The same or corresponding elements are denoted by the same symbols throughout the drawings, and duplicated explanations are omitted as necessary for the sake of clarity.

Embodiments described below will be explained mainly using specific examples with regard to an Evolved Packet System (EPS). However, these embodiments are not limited to being applied to the EPS and may also be applied to other mobile communication networks or systems such as a 3GPP (UMTS), a 3GPP2 CDMA2000 system, a GSM/GPRS system, and a WiMAX system.

### First Embodiment

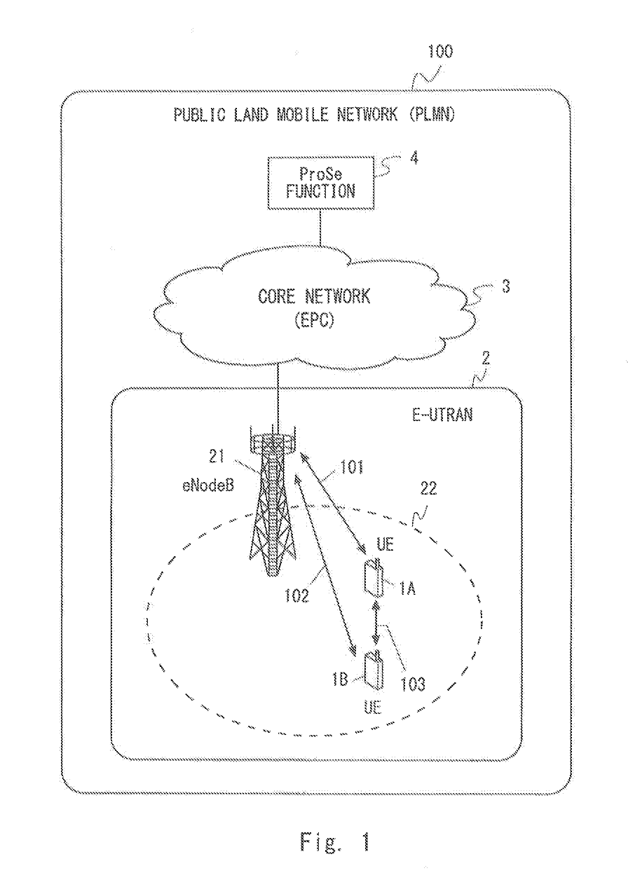

FIG. 1 shows a configuration example of a PLMN 100 according to this embodiment. Both a UE 1A and a UE 1B are radio terminals adapted to ProSe (i.e., ProSe-enabled UEs) and capable of establishing a ProSe communication path 103 and performing ProSe direct communication (or ProSe communication, inter-terminal direct communication, or D2D communication) between them. The ProSe direct communication between the UEs 1A and 1B may be performed by using a radio communication technology that is also used to access a base station (eNodeB) 21 (i.e., E-UTRA technology) or by using a WLAN radio technology (IEEE 802.11 radio technology).

The eNodeB 21 is an entity located in a radio access network (i.e., E-UTRAN) 2, manages a cell 22, and is able to perform communication (101 and 102) with the UEs 1A and 1B by using the E-UTRA technology. While FIG. 1 shows a situation where both the UE 1A and UE 1B are located in the identical cell 22 for the sake of clarity, such a UE arrangement, is merely an example. For example, the UE 1A may be located within one of adjacent cells managed by different eNodeBs 21 and the UE 1B may be located within the other of the adjacent cells.

A core network (i.e., EPC) 3 includes a plurality of user-plane entities (e.g., a Serving Gateway (S-GW) and a Packet Data Network Gateway (P-GW)) and a plurality of control-plane entities (e.g., Mobility Management Entity (MME) and a Home Subscriber Server (HSS)). The user-plane entities relay user data of the UEs 1A and 1B between the E-UTRAN 2 and an external network (Packet Data Network (PDN)). The control-plane entitles perform various types of control for the UEs 1A and 1B including mobility management, session management (bearer management), subscriber information management, and billing management.

In order to use a ProSe service (e.g., one or both of EPC-level ProSe Discovery and ProSe Direct Communication), each of the UEs 1A and 1B attaches to the EPC 3 through the E-UTRAN 2, establishes a Packet Data Network (PDN) connection for communicating with a ProSe function entity 4, and transmits and receives ProSe control signaling to and from the ProSe function entity 4 through the E-UTRAN 2 and the EPC 3. The UEs 1A and 1B may use EPC-level ProSe Discovery provided by the ProSe function entity 4. The UEs 1A and 1B may receive, from the ProSe function entity 4, a message indicating permission for the UEs 1A and 1B to activate (enable) ProSe Direct Discovery or ProSe Direct Communication. The UEs 1A and 1B may receive, from the ProSe function entity 4, configuration information for ProSe Direct Discovery or ProSe Direct Communication in the cell 22.

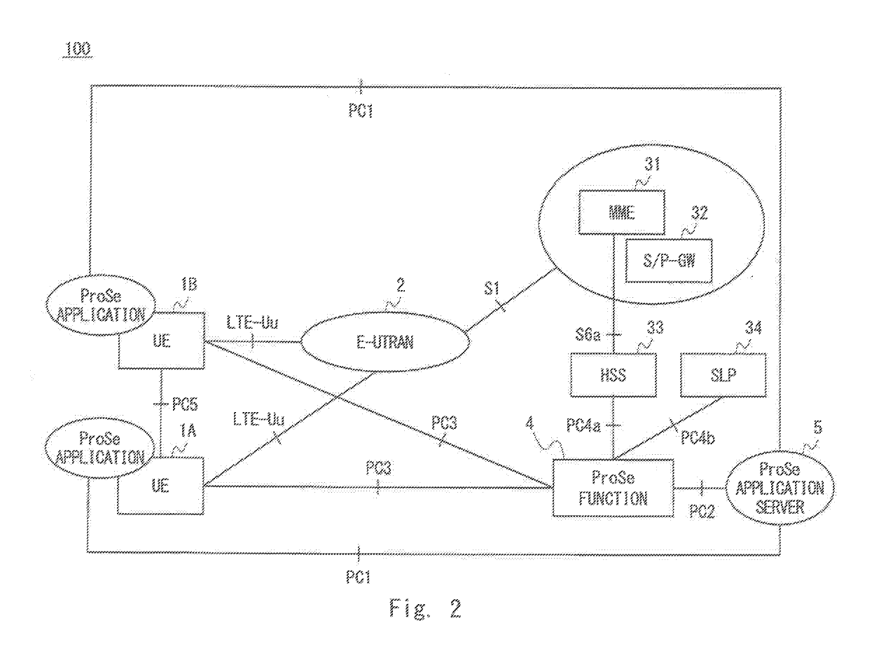

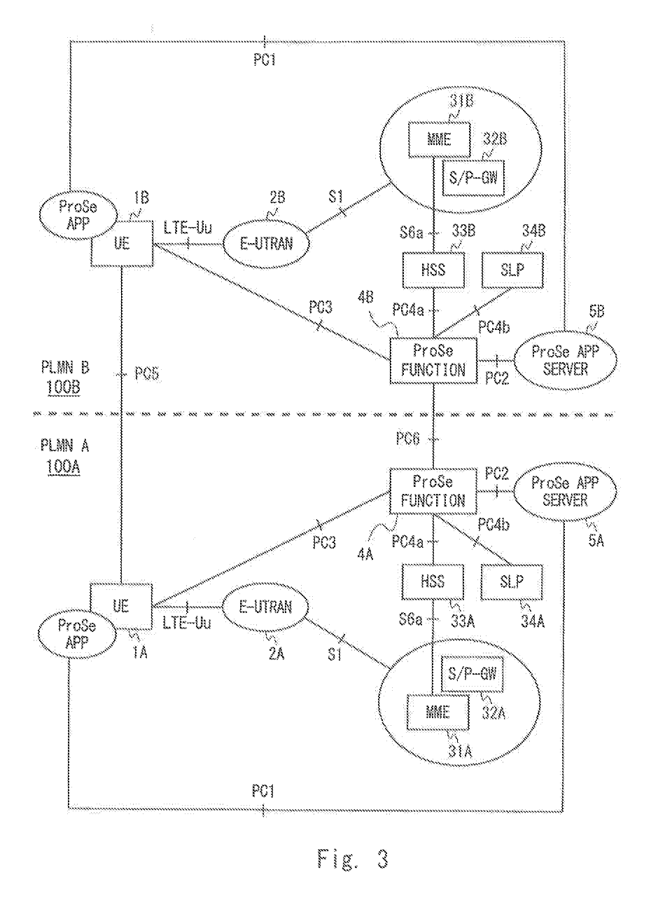

FIGS. 2 and 3 show reference points used for ProSe. Each reference point is also referred to as an “interface”. FIG. 2 shows a non-roaming architecture in which the UEs 1A and 1B use subscriptions of the same PLMN 100, and FIG. 3 shows a non-roaming inter-PLMN architecture. In FIG. 3, a PLMN A (100A) is a Home PLMN (HPLMN) of the UE 1A and a PLMN B (100B) is an HPLMN of the UE 1B. In FIG. 3, a ProSe application server SB may be integrated with a ProSe application server 5A.

A PCI reference point is a reference point between a ProSe application in each UE 1 (the UEs 1A and 1B) and a ProSe application server 5. The PC1 reference point is used to define application-level signaling requirements.

A PC2 reference point is a reference point between the ProSe application server 5 and the ProSe function entity 4. The PC2 reference point is used to define interactions between the ProSe application server 5 and the ProSe functionality provided by the 3GPP EPS through the ProSe function entity 4.

A PCS reference point is a reference point between each UE 1 (the UEs 1A and 1B) and the ProSe function entity 4. The PC3 reference point is used to define interactions between the UE 1 and the ProSe function entity 4 (e.g., UE registration, application registration, and authorizations for ProSe Direct Discovery and EPC-level ProSe Discovery requests). The PC3 reference point depends on the user plane of the EPC 3 and, accordingly, ProSe control signaling between each UE 1 and the ProSe function entity 4 is transferred on this user plane.

A PC4a reference point is a reference point between the ProSe function entity 4 and an HSS 33. This reference point is used by the ProSe function entity 4, for example, to acquire subscriber information related to ProSe services.

A PC4b reference point is a reference point between the ProSe function entity 4 and a Secure User Plane Location (SUPL) Location Platform (SLP) 34. This reference point is used by the ProSe function entity 4, for example, to acquire intermittent location reporting indicating the current locations of each UE 1 (the UEs 1A and 1B). The SLP assists the UEs 1 in GPS positioning and receives measurement results from the UEs 1, thereby intermittently acquiring, from the UE 1, location reporting by which the current locations of the UEs 1 can be estimated.

A PCS reference point is a reference point between UEs 1 (ProSe-enabled UEs), and is used for the control and user planes of ProSe Direct Discovery, ProSe Direct Communication, and ProSe UE-to-Network Relay.

As shown in FIG. 3, a PC6 reference point is a reference point between ProSe function entities 4A and 4B in different PLMNs (in the case of EPC-level ProSe Discovery). For example, this reference point is used by the ProSe function entity 4A, in the PLMN A in EPC-level ProSe Discovery, to send to the ProSe function entity 4B in the PLMN B a request for reporting on the current location of the UE 1B and to receive a report on the current location of the UE 1B.

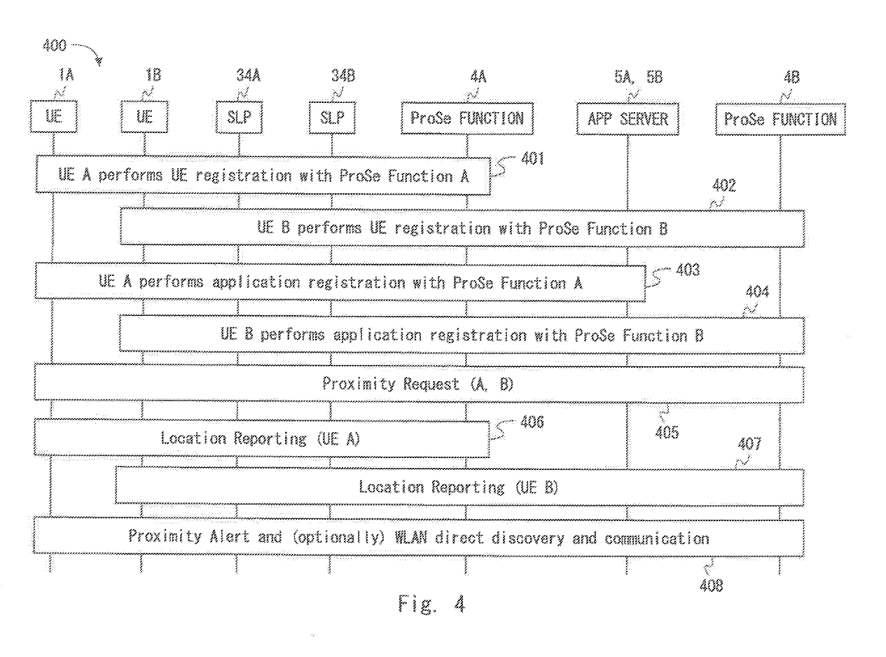

FIG. 4 shows an outline of the EPC-level ProSe Discovery procedure (process 400). Blocks 401 to 404 are the registration phase in which UEs and applications are registered for ProSe. In block 401, the UE 1A performs UE registration for ProSe with the ProSe function entity 4A residing in its HPLMN (the PLMN 100A). In block 402, the UE 1B performs UE registration for ProSe with the ProSe function entity 4B residing in its HPLMN (the PLMN 100B).

In block 403, the UE 1A performs application registration for ProSe with the ProSe function entity 4A residing in its HPLMN (the PLMN 100A). In block 404, the UE 1B performs application registration for ProSe with the ProSe function entity 4B residing in its HPLMN (the PLMN 100B).

Blocks 405 to 408 are a discovery phase. In block 405, the UE 1A sends a Proximity Request to request the ProSe function entity 4A that it be alerted for proximity with UE 1B. The proximity request triggers the ProSe function entity 4A to start EPC-level ProSe Discovery. In response to receiving the proximity request, the ProSe function entity 4A requests location reporting from the UEs 1A and 1B. The location reporting may be periodic, based on a trigger, or a combination thereof. Specifically, to request location reporting on the UE 1A, the ProSe function entity 4A communicates with an SEP 34A. To request location updates indicating the current location of the UE 1B, the ProSe function entity 4A communicates with the ProSe function entity 4B in order, which requests location reporting on the UE 1B from an SEP 34B.

in other words, in block 405, the ProSe function entity 4A communicates with at least one of the UEs 1A and 1B to perform EPC-level ProSe Discovery for detecting proximity of the UEs 1A and 1B. This EPC-level ProSe Discovery includes tracking the locations of the UEs 1A and 1B by the ProSe function entity 4A. The tracking of the locations of the UEs 1A and 1B can also be expressed as collection (or acquisition or monitoring) of the locations. Specifically, in the case of the non-roaming architecture shown in FIG. 2, the ProSe function entity 4A communicates with both of the UEs 1A and 1B. Meanwhile, in the case of the non-roaming inter-PLMN architecture shown in FIG. 3, the ProSe function entity 4A communicates with the UE 1A and also communicates with the ProSe function entity 4B to request location updates for the UE 1B.

In blocks 406 and 407, the UEs 1A and 1B intermittently report their locations to their respective ProSe function entities 4A and 4B. The ProSe function entity 4B forwards the location updates for the UE 1B to the ProSe function entity 4A. The ProSe function entity 4A tracks the current locations of the UEs 1A and 1B and determines proximity of the UEs 1A and 1B based on their current locations.

When the ProSe function entity 4A detects that the UEs 1A and 1B are in proximity, it alerts the UE 1A about proximity of the UE 1B (block 408). When WLAN direct discovery and communication are performed, the ProSe function entity 4A may send, to the UE 1A, assistance information for WLAN direct discovery and communication with the UE 1B. Further, the ProSe function entity 4A informs the ProSe function entity 4B of the proximity and the ProSe function entity 4B alerts the UE 1B about proximity of the UE 1A. The ProSe function entity 4B may send, to the UE 1B, assistance information for WLAN direct discovery and communication with the UE 1A.

The following provides details about an operation for acquiring a location history performed by the ProSe function entity 4. As already explained, the ProSe function entity 4 (4A or 4B) is configured to control network-level discovery (i.e., EPC-level ProSe Discovery) in order to detect proximity of the UEs 1A and 1B. Further, the ProSe function entity 4 (4A or 4B) is configured to acquire at least a location history of the UE 1A before starting EPC-level ProSe Discovery triggered by a request for the EPC-level ProSe Discovery (i.e., Proximity Request) issued from the UE 1A. These configurations allows the ProSe function entity 4 (4A or 4B) to take into account at least the location history of the UE 1A when determining whether to start network-level discovery. For example, the ProSe function entity 4 may estimate whether the UEs 1A and 1B have a tendency to enter proximity to each other in the future based on the location history of the UE 1A. When the ProSe function entity 4 (4A or 4B) has determined that it does not start the EPC-level ProSe Discovery in consideration of the location history of the UE 1A, it may reject the request (i.e., Proximity Request) from the UE PA. Applying the above-described operation, it is possible to contribute to improving accuracy of a determination whether to start network-level discovery (e.g., EPC-level ProSe Discovery).

The ProSe function entity 4 may acquire a location history of the UE 1B in addition to the location history of the UE 1A. The ProSe function entity 4 may acquire the location history of the UE 1B in advance.

The location history of the UE 1A may indicate a plurality of information elements obtained by measurements performed at different times. In this way, the ProSe function entity 4 can know a plurality of past locations of the UE 1A and thus can easily estimate the moving direction of the UE 1A or easily detect proximity of the UEs 1A and 1B in the past, as described later.

In some implementations, the ProSe function entity 4 may estimate the moving direction of the UE 1A based on the location history of the UE 1A and take into account the moving direction of the UE 1A when determining whether to start network-level discovery. For example, the ProSe function entity 4 may estimate whether the UEs 1A and 1B have a tendency to enter proximity to each other in the future by using the moving direction of the UE 1A. In this ease, as for the UE 1B, the ProSe function entity 4 may use the last known location (e.g., a cell or a tracking area) of the UE 1B acquired from the HSS 33. Alternatively, the ProSe function entity 4 may further acquire the location history of the UE 1B and estimate the moving direction of the UE 1B based on the acquired location history.

In some implementations, when the ProSe function entity 4 determines whether to start network-level discovery, it may take into account whether or not the UEs 1A and 1B have ever been in proximity to each other in the past based on the location history of the UE 1A. When the UEs 1A and 1B have been in proximity to each other before, the ProSe function entity 4 may determine that there is a high possibility that the UEs 1A and 1B has a tendency to enter proximity to each other in the future. In this case, as for the UE 1B, the ProSe function entity 4 may use the last known location (e.g., a cell or a tracking area) of the UE 1B acquired from the HSS 33. Alternatively, the ProSe function entity 4 may further acquire the location history of the UE 1B and determine whether the UEs 1A and 1B have been in proximity to each other in the past based on the location histories of the UEs 1A and 1B.

For example, the ProSe function entity 4 may determine that the UEs 1A and 1B have been in proximity to each other before, when the number of samples in which the inter-terminal distance between the UEs 1A and 1B is equal to or shorter than a predetermined value exceeds a threshold.

Alternatively, the ProSe function entity 4 may determine that the UEs 1A and 1B have been in proximity to each other before, when a statistical value of the inter-terminal distance between the UEs 1A and 1B calculated based on the location history is equal to or shorter than a threshold.

Additionally or alternatively, the ProSe function entity 4 may use a least squares method to obtain a linear function of time that approximates a plurality of samples of the inter-terminal distance between the UEs 1A and 1B obtained from the location history and then predict an inter-terminal distance in the future based on this approximate function. The ProSe function entity 4 may determine a start of EPC-level ProSe Discovery when the predicted inter-terminal distance in the future is equal to or shorter than a threshold.

In some implementations, each of the location histories of the UEs 1A and 1B may include location information for specifying the location of the UE 1 (1A or 1B) and time information for specifying a time at which this location information was obtained. The time information may be an absolute time stamp indicating an absolute time or may be a relative time stamp indicating a relative time.

In some implementations, each of the location histories of the UEs 1A and 1B may include information indicating a location at a cell level (e.g., E-UTRAN Cell Global ID (ECGI), or Cell-Id of a serving cell).

In some implementations, each of the location histories of the UEs 1A and 1B may include Global Navigation Satellite System (GNSS) location information obtained by a GNSS receiver. The GNSS location information indicates latitude and longitude.

In some implementations, each of the location histories of the UEs 1A and 1B may include Radio Frequency (RF) fingerprints. The RF fingerprints include information about peripheral cell measurement (e.g., cell ID (ECGI, Cell-Id) and Reference Signal Received Power (RSRP)) measured by the UE 1 (1A or 1B).

In some implementations, each of the location histories of the UEs 1A and 1B may include location information and time information contained in Logged MOT measurement data obtained by the Minimization of Drive Tests (MDT) function of the UE 1A (or 1B). The Logged MDT measurement data includes, for example, cell-level location information as described above, GNSS location information, RF fingerprints, or any combination thereof. By using the Logged MDT measurement data, it is possible to use the ordinary MDT function specified in the current 3GPP specifications and thereby to reduce the impacts on the existing specifications regarding the UE 1.

In some implementations, each of the location histories of the UEs 1A and 1B may include location information and time information obtained by a plurality of measurements performed when the UE 1A (or 1B) is in an idle state in which it is not wirelessly connected to the eNodeB 21 (i.e., in an RRC_IDLE state). An example of information obtained in the idle state (i.e., RRC_IDLE state) is the above-described location information and time information contained in Logged MDT measurement data.

In some implementations, each of the location histories of the UEs 1A and 1B may include location information and time information obtained by a plurality of measurements performed when the UEs 1A (or 1B) is in a connected state where it is wirelessly connected to the eNodeB 21 (i.e., in an RRC_CONNECTED state).

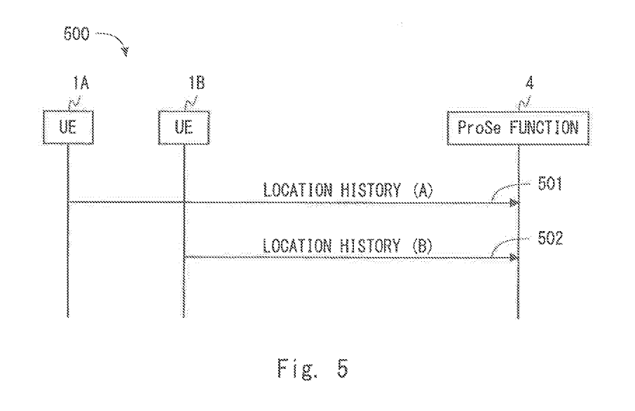

FIG. 5 is a sequence diagram showing an example of an operation (process 500) performed by the ProSe function entity 4 for acquiring location histories of the UEs 1A and 1B. FIG. 5 shows the non-roaming architecture in which the UEs 1A and 1B use subscriptions of the same PLMN 100. As shown in FIG. 5, the ProSe function entity 4 may receive location histories of the UEs 1A and 1B directly from the UEs 1A and 1B, i.e., through the PC3 reference point (blocks 501 and 502).

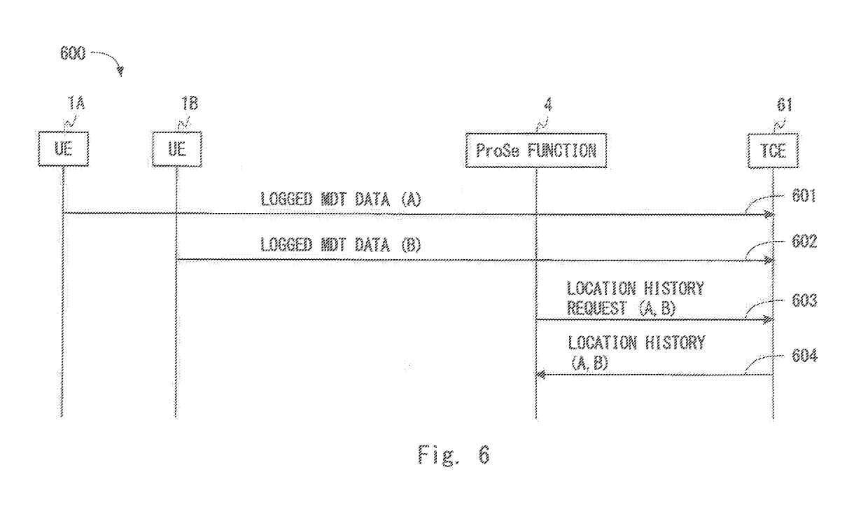

FIG. 6 is a sequence diagram showing another example of an operation (process 600) performed by the ProSe function entity 4 for acquiring location histories of the UEs 1A and 1B. FIG. 6 shows the non-roaming architecture. As shown in FIG. 6, the ProSe function entity 4 may receive location histories of the UEs 1A and 1B via a server. In the example shown in FIG. 6, the location histories are Logged MDT measurement data. The UEs 1A and 1B send Logged MDT measurement data to a Trace Collection Entity (TCE) 61 (blocks 601 and 602) and the ProSe function entity 4 receives location histories of the UEs 1A and 1B from the TCE 61 (blocks 603 and 604). Note that the server, which mediates the transfer of the location histories between the UEs 1 and the ProSe function entity 4, may be a server other than the TCE, e.g., the SLP 34.

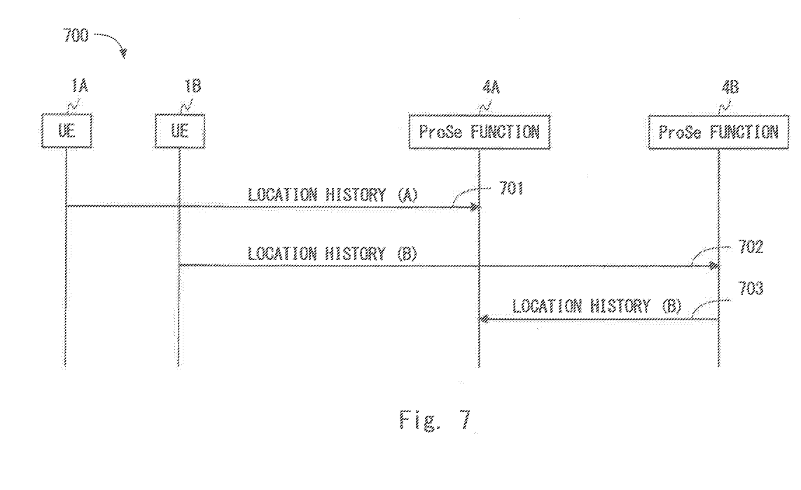

FIG. 7 is a sequence diagram showing still another example of an operation (process 700) performed by the ProSe function entity 4 for acquiring location histories of the UEs 1A and 1B. FIG. 7 shows the non-roaming inter-PLMN architecture. In this case, the ProSe function entity 4A may receive location history of the UE 1A directly from the UE 1A through the PC3 reference point (block 701) and indirectly receive location history of the UE 1B via the ProSe function entity 4B (blocks 702 and 703).

The operation shown in FIG. 7 may be combined with the operation shown in FIG. 6. That is, the ProSe function entity 4A may receive location information of the UE 1A from a TCE (or another server) in the PLMN A (100A). Similarly, the ProSe function entity 4B may receive location information of the UE 1B from a TCE (or another server) in the PLMN B (100B).

Note that FIGS. 5 to 7 show examples in which the ProSe function entity 4 acquires the location histories of the UEs 1A and 1B. However, as already explained, the ProSe function entity 4 may acquire only the location history of the UE 1A that has requested a network-level discovery (i.e., EPC-level ProSe Discovery). In this case, as for the UE 1B, the ProSe function entity 4 may use the last known location (e.g., cell or tracking area) of the UE 1B acquired from the HSS 33.

Various specific examples of the operation for acquiring location histories of the UEs 1A and 1B performed by the ProSe function entity 4 and the use of the location histories are explained in a more detailed manner in the following embodiments.

### Second Embodiment

This embodiment provides a specific example of the operation for acquiring location histories of the UEs 1A and 1B performed by the ProSe function entity 4 and the use of these location histories explained in the first embodiment. A configuration example of a public land mobile network according to this embodiment is similar to that shown in FIGS. 1 to 3. Further, an outline of the EEC-level ProSe Discovery procedure according to this embodiment is similar to the procedure shown in FIG. 4.

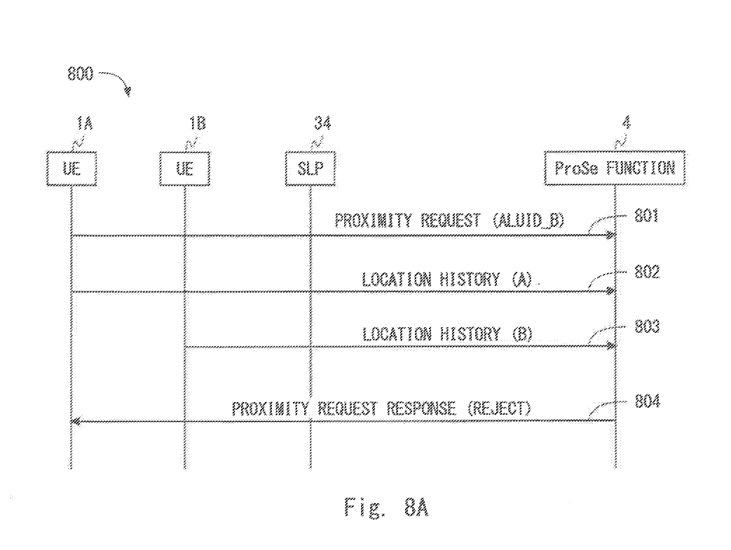

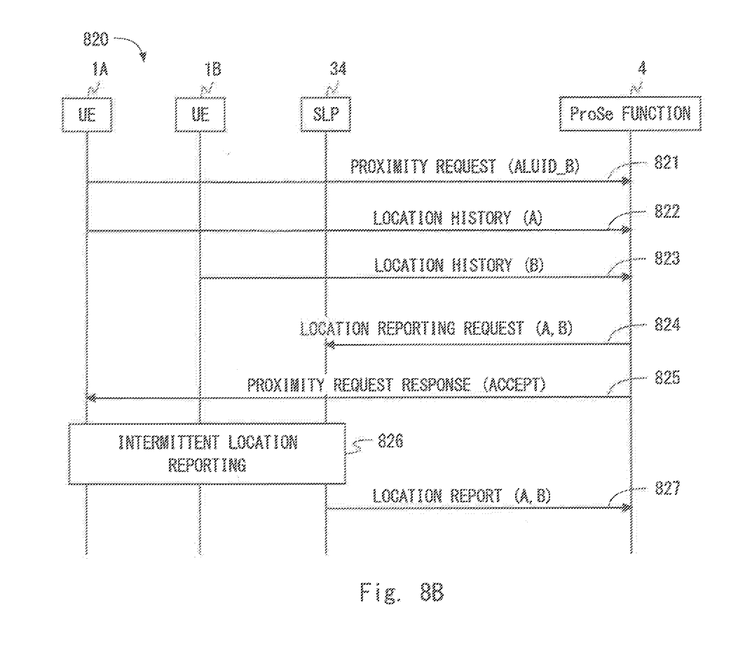

FIG. 8A is a sequence diagram showing an example (process 800) of the EPC-level ProSe Discovery procedure according to this embodiment. FIG. 8A shows the non-roaming architecture. In block 801, the ProSe function entity 4 receives a Proximity Request from the UE 1A. This proximity request indicates an Application Layer User ID (ALUID_B) of the UE 1B and requests EPC-level ProSe Discovery for detecting proximity to the UE 1B.

In blocks 802 and 803, the ProSe function entity 4 receives from the UEs 1A and 1B their respective location histories. As in the case of some examples explained above in the first embodiment, the ProSe function entity 4 may directly receive the location histories of the UEs 1A and 1B through the PC3 reference point or may indirectly receive them through a server (e.g., TCE or SEP).

The ProSe function entity 4 may acquire the location histories in blocks 802 and 803 in response to receiving the proximity request in block 801. For example, in response to receiving the proximity request from the UE 1A. the ProSe function entity 4 may send a location history request to the UEs 1A and 1B and receive location histories from the UEs 1A and 1B. Alternatively, the ProSe function entity 4 may acquire the location history of at least one of the UEs 1A and 1B in a periodic or non-periodic manner before receiving the proximity request in block 801.

In block 804, the ProSe function entity 4 takes into account the location histories of the UEs 1A and 1B when it determines whether to start EPC-level ProSe Discovery for the UEs 1A and 1B. In other words, the ProSe function entity 4 determines whether to start EPC-level ProSe Discovery for the UEs 1A and 1B based on the location histories of the UEs 1A and 1B. In the example shown in FIG. 8A, the ProSe function entity 4 determines that the UEs 1A and 1B are unlikely to enter proximity to each other within a requested time window. Accordingly, the ProSe function entity 4 does not start EPC-level ProSe Discovery and sends to the UE 1A a reject message (i.e., Proximity Request Response (Reject)) indicating the rejection of the proximity request. This reject message may indicate a cause value corresponding to a state where proximity is unlikely to be detected within the requested time window (i.e., “Proximity detection unlikely within requested time window”). Alternatively, this reject message may indicate a new cause value indicating that the proximity request is rejected based on the location history.

FIG. 8B shows a modified example (process 820) of the example shown in FIG. 8A, in which the ProSe function entity 4 accepts the proximity request from the UE 1A. Processes in blocks 821 to 823 are similar to those in blocks 801 to 803 in FIG. 8A. Processes in blocks 824 to 827 are similar to those in the ordinary procedure (the process 400 in FIG. 4) performed when EPC-level ProSe Discovery is started. Specifically, in block 824, the ProSe function entity 4 sends a Location Reporting Request to the SEP 34 to request location reporting indicating the current locations of the UEs 1A and 1B from the SEP 34. In block 825, the ProSe function entity 4 sends to the UE 1A an accept message (i.e., Proximity Request Response (Accept)) indicating that the UE 1A is permitted to use EPC-level ProSe Discovery.

In block 826, the UEs 1A and 1B send intermittent location reporting indicating their respective current locations to the SEP 34. In block 827, the ProSe function entity 4 receives from the SEP 34 the intermittent location reporting indicating the current locations of the UEs 1A and 1B. While not shown in FIG. 8B, the ProSe function entity 4 detects proximity of the UEs 1A and 1B based on the location reporting on the UEs 1A and 1B according to the ordinary EPC-level ProSe Discovery procedure.

Note that FIGS. 8A and 8B show examples in which the ProSe function entity 4A acquires the location histories of the UEs 1A and 1B. However, as explained in the first embodiment, the ProSe function entity 4A may acquire only the location history of the UE 1A that has requested a network-level discovery (i.e., EPC-level ProSe Discovery). In this case, as for the UE 1B, the ProSe function entity 4A may use the last known location (e.g., cell or tracking area) of the UE 1B acquired from the HSS 33.

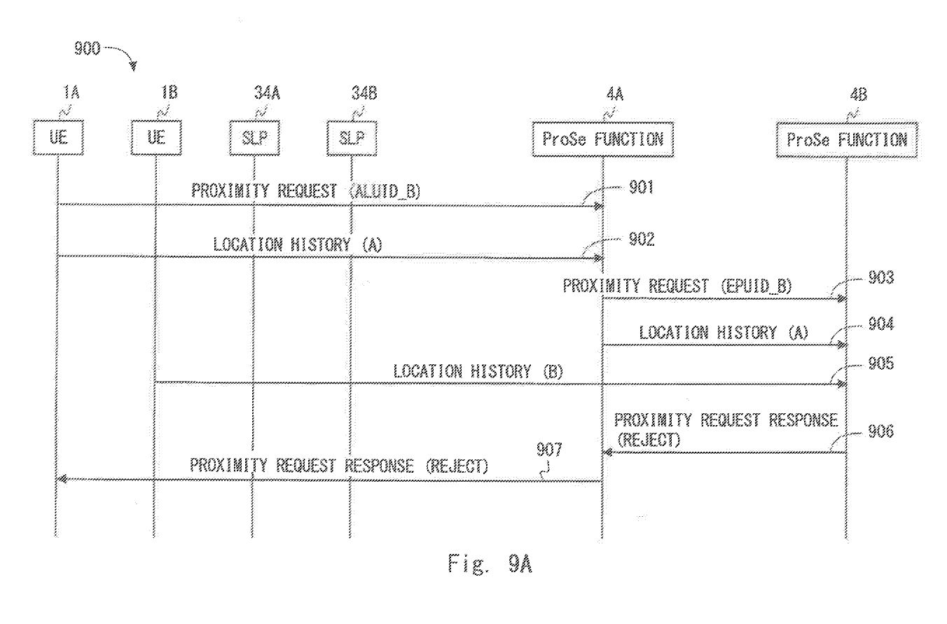

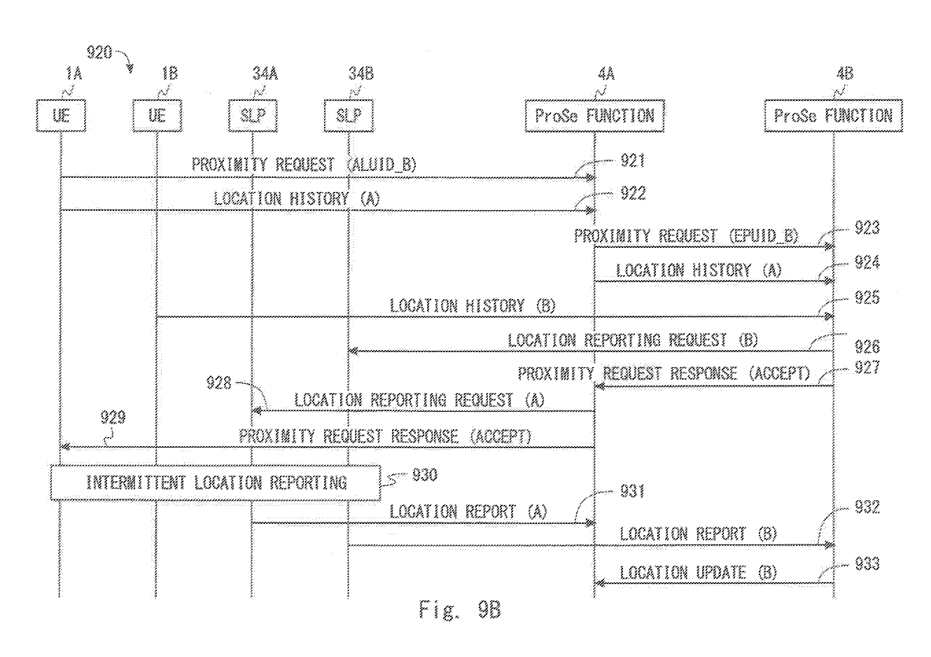

FIG. 9A is a sequence diagram showing an example of the EPC-level ProSe Discovery procedure (process 900) according to this embodiment. FIG. 9A shows the non-roaming inter-PLMN architecture. In the example shown in FIG. 9A, the ProSe function entity 4B, instead of the ProSe function entity 4A, determines whether to start EPC-level ProSe Discovery.

In block 901, the ProSe function entity 4A receives a Proximity Request from the UE 1A. This proximity request indicates an Application Layer User ID (ALUID_B) of the UE 1B and requests EPC-level ProSe Discovery for detecting proximity to the UE 1B, in block 902, the ProSe function entity 4A receives from the UE 1A a location history of the UE 1A. The ProSe function entity 4A may directly receive the location history of the UE 1A through the PC3 reference point or may indirectly receive it through a server (e.g., TCE or SLP). The ProSe function entity 4A may acquire the location history in block 902 in response to receiving the proximity request in block 901. Alternatively, the ProSe function entity 4A may acquire the location history of the UE 1A before receiving the proximity request in block 901.

In block 903, the ProSe function entity 4A sends the proximity request to the ProSe function 4B that manages the UE 1B. In blocks 904 to 906, the ProSe function 4B determines whether to accept the proximity request, i.e., determines whether to start EPC-level ProSe Discovery. Specifically, in block 904, the ProSe function entity 4B receives the location history of the UE 1A from the ProSe function entity 4A. In block 905, the ProSe function entity 4B receives a location history of the UE 1B directly from the UE 1B or receives it indirectly through a server.

In block 906, the ProSe function entity 4B determines whether to start EPC-level ProSe Discovery for the UEs 1A and 1B based on the location histories of the UEs 1A and 1B. In the example shown in FIG. 9A, the ProSe function entity 4B determines that the UEs 1A and 1B are unlikely to enter proximity to each other within a requested time window. Accordingly, the ProSe function entity 4B sends a reject message (i.e., Proximity Request Response (Reject)) indicating the rejection of the proximity request to the ProSe function entity 4A. In block 907, the ProSe function entity 4A sends this reject message to the UE 1A.

FIG. 9B shows a modified example (process 920) of the example shown in FIG. 9A, in which the ProSe function entities 4A and 4B accept the proximity request from the UE 1A. Processes in blocks 921 to 925 are similar to those in blocks 801 to 805 in FIG. 9A. Processes in blocks 926 to 933 are similar to those in the ordinary procedure (the process 400 in FIG. 4) performed when EPC-level ProSe Discovery is started. Specifically, in block 926, the ProSe function entity 4B sends a Location Reporting Request to the SEP 34B to request location reporting indicating the current location of the UE 1B from the SLP 34B. In block 927, the ProSe function entity 4B sends to the ProSe function entity 4A an accept message (i.e., Proximity Request Response (Accept)) indicating the acceptance of the proximity request.

In block 928, the ProSe function entity 4A sends a Location Reporting Request to the SLP 34A to request location reporting indicating the current location of the UE 1A from the SLP 34A. In block 929, the ProSe function entity 4A sends to the UE 1A an accept message (i.e., Proximity Request Response (Accept)) indicating that the UE 1A is permitted to use EPC-level ProSe Discovery.

In block 930, the UEs 1A and 1B send intermittent location reporting indicating their respective current locations to the SLPs 34A and 34B, respectively. In block 931, the ProSe function entity 4A receives the intermittent location reporting indicating the current location of the UE 1A from the SLP 34A. Similarly, in block 932, the ProSe function entity 4B receives the intermittent location reporting indicating the current location of the UE 1B from the SLP 34B. In block 933, the ProSe function entity 4B sends to the ProSe function entity 4A a location update message (i.e., Location Update) indicating the current location of the UE 1B. While not shown in FIG. 9B, the ProSe function entity 4A detects proximity of the UEs 1A and 1B based on the location reporting (or the location update) on the UEs 1A and 1B.

Note that FIGS. 9A and 9B show examples in which the ProSe function entity 4B acquires the location histories of the UEs 1A and 1B. However, as explained in the first embodiment, the ProSe function entity 4B may acquire only the location history of the UE 1A that has requested a network-level discovery (i.e., EPC-level ProSe Discovery). In this case, as for the UE 1B, the ProSe function entity 4B may use the last known location (e.g., cell or tracking area) of the UE 1B acquired from the HSS 33.

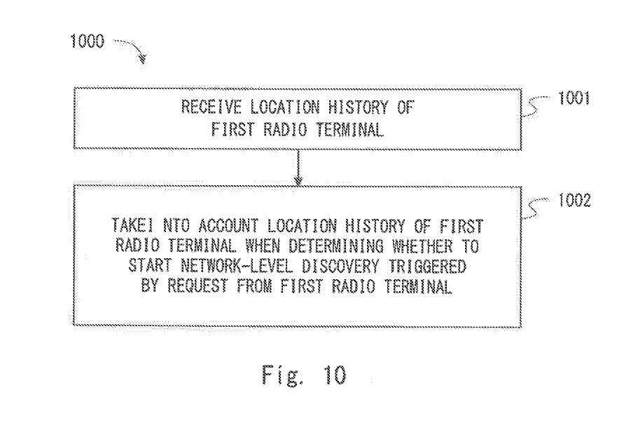

FIG. 10 is a flowchart showing an example of an operation (process 1000) performed by the ProSe function entity 4 (4A and 4B) according to this embodiment. In block 1001, the ProSe function entity 4 receives a location history of a first radio terminal (i.e., UE 1A). In block 1002, the ProSe function entity 4 takes into account at least the location history of the first radio terminal (UE 1A) when determining whether to start network-level discovery (i.e., EPC-level ProSe Discovery) triggered by a request from the first radio terminal (UE 1A). In other words, the ProSe function entity 4 determines whether to start EPC-level ProSe Discovery for the UEs 1A and 1B based on at least the location history of the UE 1A.

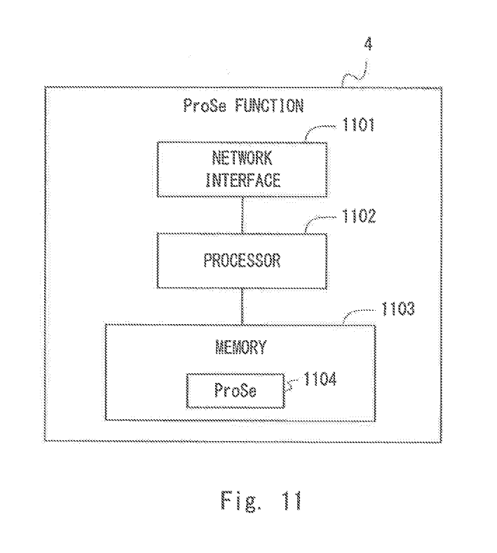

Lastly, configuration examples of the ProSe function entities 4 (4A and 4B) and the UEs 1 (1A and 1B) according to the above-described embodiments are explained. FIG. 11 shows a configuration example of the ProSe function entity 4. Referring to FIG. 11, the ProSe function entity 4 includes a network interface 1101, a processor 1102, and a memory 1103, The network interface 1101, the processor 1102, the memory 1103, or any combination thereof can be referred to as circuits or circuitry. The network interface 1101 is used to communicate with a network node (e.g., an HSS 33 and an S/P-GW 32). The network interface 1101 may include, for example, a Network Interface Card (NIC) conforming to the IEEE 802.3 series.

The processor 1102 loads software (computer program) from the memory 1103 and executes these loaded software, and thereby performs processes of the ProSe function entity 4 i.e., the processes explained with reference to the sequence diagrams and the flowchart in the above-described embodiments (e.g., the process 400, 500, 600, 700, 800, 820, 900, 920 or 1000). The processor 1102 may be, for example, a microprocessor, a Micro Processing Unit (MPU), or a Central Processing Unit (CPU). The processor 1102 may include a plurality of processors.

The memory 1103 consists of a volatile memory and a nonvolatile memory. The volatile memory is, for example, a Static Random Access Memory (SRAM), a Dynamic RAM (DRAM), or a combination of them. The nonvolatile memory is, for example, a Mask Read Only Memory (MROM), a Programmable ROM (PROM), a flash memory, a hard disk drive, or any combination of them. Further, the memory 1103 may include a storage that is remotely arranged from the processor 1102. In this case, the processor 1102 may access the memory 1103 through an I/O interface (not shown).

In the example shown in FIG. 11, the memory 1103 is used to store software modules including a ProSe module 1104. The ProSe module 1104 includes instructions and data necessary for performing processes of the ProSe function entity 4 explained in the above-described embodiments. The processor 1102 loads software modules including the ProSe module 1104 from the memory 1103 and executes these loaded modules, and thereby performing the processes of the ProSe function entity 4 explained in the above-described embodiments.

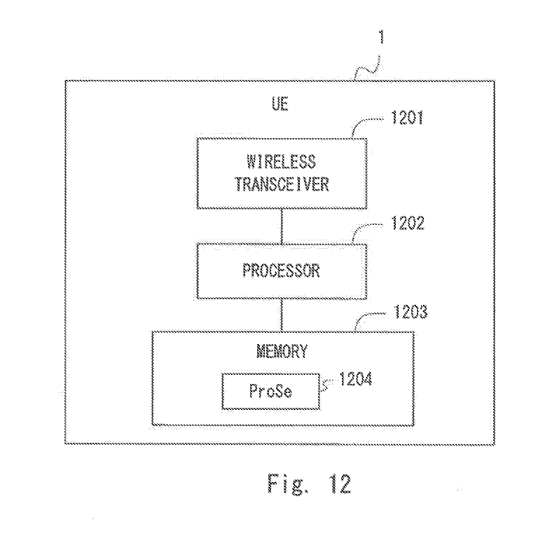

FIG. 12 shows a configuration example of the UE 1. Referring to FIG. 12, the UE 1 includes a wireless transceiver 1201, a processor 1202, and a memory 1203. The wireless transceiver 1201, the processor 1202, the memory 1203 or any combination thereof can be referred to as circuits or circuitry. The wireless transceiver 1201 is used for communication (101 or 102 in FIG. 1) with the E-UTRAN 2 (eNodeB 21) and for the ProSe direct communication (103 in FIG. 1). The wireless transceiver 1201 may include a plurality of transceivers, for example, an E-UTRA (Long Term Evolution (LTE)) transceiver and a WEAN transceiver.

The processor 1202 loads software (computer program) from the memory 1203 and executes the loaded software, and thereby performs processes of the UE 1 i.e., the processes explained with reference to the sequence diagrams and the flowchart in the above-described embodiments (e.g., the process 400, 500, 600, 700, 800, 820, 900 or 920). The processor 1202 may be, for example, a microprocessor, an MRU, or a CPU. The processor 1202 may include a plurality of processors.

The memory 1203 consists of a volatile memory and a nonvolatile memory. The volatile memory is, for example, an SRAM, a DRAM, or a combination of them. The nonvolatile memory is, for example, an MROM, a PROM, a flash memory, a hard disk drive, or any combination of them. The memory 1203 may include a storage that is located apart from the processor 1202. In this case, the processor 1202 may access the memory 1203 through an I/O interface (not shown).

In the example shown in FIG. 12, the memory 1203 is used to store software modules including a ProSe module 1204. The ProSe module 1204 includes instructions and data necessary for performing processes of the UE 1 explained in the above-described embodiments. The processor 1202 loads software modules including the ProSe module 1204 from the memory 1203 and executes these loaded modules, and thereby performing the processes of the UE 1 explained in the above-described embodiments.

As explained above with reference to FIGS. 11 and 12, each of the processors included in the ProSe function entity 4, the HSS 33, and the UE 1 according to the above-described embodiments executes one or more programs including instructions to cause a computer to perform an algorithm explained with reference to the drawings. These programs may be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a Compact Disc Read Only Memory (CD-ROM), CD-R, CD-R/W, and a semiconductor memory (such as a mask ROM, a Programmable ROM (PROM), an Erasable PROM (EPROM), a flash ROM, and a Random Access Memory (RAM)). These programs may be supplied to computers by using various types of transitory computer readable media. Examples of the transitory computer readable media include an electrical signal, an optical signal, and an electromagnetic wave. The transitory computer readable media can be used to supply programs to a computer through a wire communication path such as an electrical wire and an optical fiber, or wireless communication path.

### Other Embodiments

Each of the above-described embodiments may be used individually, or two or more of the embodiments may be appropriately combined with one another.

In the above-described embodiments, examples in which Logged MDT data is used for network-level discovery (i.e., EPC-level ProSe Discovery) as well as for the MDT are shown. Conversely, the location history that is originally obtained for the network-level discovery may also be used for the MDT.

Note that when proximity of the UEs 1A and 1B in EPC-level ProSe Discovery can be detected from the acquired location histories of the UEs 1A and 1B, the Location Reporting (UE A) 406 and the Location Reporting (UE B) 407 in FIG. 4 may be skipped. In this case, a state in which the difference between the current time and the time indicated by the time stamps in the location histories of the UEs 1A and 1B is equal to or smaller than a threshold may be used as one of the conditions for detecting proximity in EPC-level ProSe Discovery. The threshold for the UE 1A may be the same as or different from the threshold for the UE 1B. Further, the condition on the inter-terminal distance that is used to determine a start of EPC-level ProSe Discovery may be the same as or different from the condition on the inter-terminal distance that is used to detect proximity in EPC-level ProSe Discovery. Further, when the difference between the current time and the time indicated by the time stamp in the location history of either one of the UEs 1A and 1B is equal to or smaller than a threshold, the Location Reporting on the UE that satisfies this condition may be skipped while the Location Reporting on the other UE is performed.

The above-described embodiments are explained by using specific examples mainly related to the EPS. However, these embodiments may be applied to other mobile communication systems such as a Universal Mobile Telecommunications System (UMTS), a 3GPP2 CDMA2000 system (1×RTT, High Rate Packet Data (HRPD)), a Global System for Mobile communications (GSM)/General packet radio service (GPRS) system, and a mobile WiMAX system.

Further, the above-described embodiments are merely examples of applications of the technical ideas obtained by the inventor. Needless to say, these technical ideas are not limited to the above-described embodiments and various modifications can be made thereto.

This application is based upon and claims the benefit of priority from Japanese patent application No. 2015-036286, filed on Feb. 26, 2015, the disclosure of which is incorporated herein in its entirety by reference.

### REFERENCE SIGNS LIST

1A, 1B User Equipment (UE)
2 Evolved Universal Terrestrial Radio Access Network (E-UTRAN)
3 Evolved Packet Core (EPC)
4 Proximity-based Services (ProSe) function entity
5 ProSe application server
21 evolved NodeB (eNodeB)
22 cell
33 Home Subscriber Server (HSS)
34 Secure User Plane Location (SUPL) Location Platform (SEP)
61 Trace Collection Entity (TCE)
100 Public Land Mobile Network (PLMN)
103 ProSe direct communication path

1. A control apparatus comprising:
a memory; and
at least one processor coupled to the memory, wherein
the at least one processor is configured to:
control a network-level discovery including tracking current locations of first and second radio terminals to detect proximity of the first and second radio terminals; and
acquire at least a location history of the first radio terminal before starting the network-level discovery triggered by a request for the network-level discovery issued from the first radio terminal.

2. The control apparatus according to claim 1, wherein the location history of the first radio terminal indicates a plurality of location information elements obtained by measurements performed at different times

3. The control apparatus according to claim 1, wherein the location history includes location information for specifying a location of the first radio terminal and time information for specifying a time at which the location information is obtained.

4. The control apparatus according to claim 1, wherein the location history includes location information and time information contained in Logged MDT measurement data obtained by a Minimization of Drive Tests (MDT) function of the first radio terminal. cm 5. The control apparatus according to claim 1, wherein the location history includes location information and time information obtained by a plurality of measurements performed when the first radio terminal is in an idle state in which the first radio terminal is not wirelessly connected to a base station.

6. The control apparatus according to claim 1, wherein the at least one processor is configured to take into account the location history of the first radio terminal when determining whether to start the network-level discovery.

7. The control apparatus according to claim 6, wherein the at least one processor is configured to estimate a moving direction of the first radio terminal based on the location history of the first radio terminal, in order to determine whether to start the network-level discovery.

8. The control apparatus according to claim 6, wherein the at least one processor is configured to estimate, based on the location history of the first radio terminal, whether the first and second radio terminals have a tendency to enter proximity to each other in the future, in order to determine whether to start the network-level discovery.

9. The control apparatus according to claim 1, wherein the location history includes information indicating a location at a cell level.

10. The control apparatus according to claim 1, wherein the location history includes at least one of: location information obtained by a Global Navigation Satellite System (GNSS) receiver; and Radio Frequency (RF) fingerprint information.

11. The control apparatus according to claim 1, wherein the at least one processor is configured to acquire the location history of the first radio terminal in response to receiving the request for the network-level discovery issued from the first radio terminal.

12. The control apparatus according to claim 11, wherein the at least one processor is configured to reject the request from the first radio terminal when it is determined that the network-level discovery is not starred.

13. The control apparatus according to claim 11, wherein the at least one processor is configured to request intermittent reporting indicating current locations of the first and second radio terminals when it is determined that the network-level discovery is started.

14. The control apparatus according to claim 1, wherein the network-level discovery includes detecting proximity of the first and second radio terminals by using intermittent reporting indicating current locations of the first and second radio terminals.

15. The control apparatus according to claim 1, wherein the at least one processor is configured to receive the location history of the first radio terminal directly from the first radio terminal.

16. The control apparatus according to claim 1, wherein the at least one processor is configured to receive the location history of the first radio terminal through a Trace Collection Entity (TCE) that collects Logged MDT measurement data obtained by a Minimization of Drive Tests (MDT) function of the first radio terminal.

17. A radio terminal apparatus comprising:
at least one radio transceiver; and
at least one processor, wherein
the at least one processor is configured to:
request a control apparatus to perform a network-level discovery including tracking current locations of the radio terminal apparatus and another radio terminal to detect proximity of the radio terminal apparatus and the another radio terminal; and
send a location history of the radio terminal apparatus to the control apparatus directly or through a server, before the network-level discovery is started.

18. The radio terminal apparatus according to claim 17, wherein the location history indicates a plurality of location information elements obtained by measurements performed at different times.

19. The radio terminal apparatus according to claim 17, wherein the location history includes location information for specifying a location of the radio terminal apparatus and time information for specifying a time at which the location information is obtained.

20-24. (canceled)

25. A method performed by a control apparatus, the method comprising:
performing a network-level discovery including tracking current locations of first and second radio terminals to detect proximity of the first and second radio terminals; and
acquiring at least a location history of the first radio terminal before starting the network-level discovery triggered by a request for the network-level discovery issued from the first radio terminal.

28-41. (canceled)
